(19) United States
(12) Patent Application Publication
(10) Pub. No.: US 2026/0220641 A1
(43) Pub. Date: Jul. 30, 2026

(54) DETERMINING RISK SCORES USING OBJECTIVE-BASED MACHINE LEARNING

(71) Applicant: Walmart Apollo, LLC, Bentonville, AR (US)

(72) Inventors: Yunhan Wen, Mountain View, CA (US); Priyanka Reddy Yellati, Sunnyvale, CA (US); Yilan Qu, San Francisco, CA (US); Tingting Xie, San Jose, CA (US)

(21) Appl. No.: 19/041,657

(22) Filed: Jan. 30, 2025

(51) Int. Cl. G06Q 20/40; G06N 20/00

(52) U.S. Cl. CPC G06Q 20/4016; G06N 20/00

(57) ABSTRACT

Examples may be related to anomaly detection using machine learning. An example may involve receiving a risk assessment request regarding a transaction; generating feature data based on the risk assessment request; and determining, using a machine learning model, a risk score based on the feature data. The machine learning model may be trained based on an objective function characterizing a plurality of objectives. Recommendation data regarding the transaction may be generated based on the risk score, and transmitted to a computing device.

### BACKGROUND

Anomaly detection is important in data analysis for safety and data optimization. For example, many service data in the retail industry are sensitive to anomaly. Users and retailers can benefit from the identification of anomalies as early as possible.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for anomaly detection using machine learning, in accordance with some embodiments;

FIG. 2 is a block diagram of an anomaly detection computing device, in accordance with some embodiments;

FIG. 3 is a block diagram illustrating various portions of a system for anomaly detection using machine learning, in accordance with some embodiments;

FIG. 4 illustrates an example process for managing transactions based on anomaly risks, in accordance with some embodiments;

FIG. 5 is a block diagram illustrating various portions of a system to accept or deny a transaction automatically based on a machine learning model, in accordance with some embodiments;

FIG. 6 is a block diagram illustrating various portions of a system to train a machine learning model for anomaly detection, in accordance with some embodiments;

FIG. 7 shows a flowchart illustrating an example method for anomaly detection using machine learning, in accordance with some embodiments;

FIG. 8 shows a flowchart illustrating an example method for training a machine learning model for anomaly detection, in accordance with some embodiments;

FIG. 9 shows a flowchart illustrating an example method for generating a label data set, in accordance with some embodiments;

FIG. 10 shows a flowchart illustrating an example method for generating a feature data set, in accordance with some embodiments;

FIG. 11 shows a flowchart illustrating an example method for re-training a machine learning model for anomaly detection, in accordance with some embodiments;

FIG. 12 shows a flowchart illustrating an example method for generating recommendation data to accept or deny a transaction, in accordance with some embodiments;

FIG. 13 depicts an example system with a machine-readable medium that includes instructions for anomaly detection using machine learning, in accordance with some embodiments.

### DETAILED DESCRIPTION

In some embodiments, systems and methods are described herein for using a machine learning model to automatically detect anomalies. Training such a machine learning model suitable for anomaly detection may require enough effective anomaly indicators.

For example, to detect anomalous transactions (e.g. a fraud transaction or fraud money transfer) and manage transaction risks, a machine learning model can be trained using anomaly indicators that are generated based on both anomalous transactions being reported by scammed victims and anomalous transactions being identified by human investigation. In some examples, to detect anomalies during money transfer, a machine learning model can be trained using anomaly indicators that are generated based on both anomalous money transfers being reported by scammed victims and anomalous money transfers being identified by human investigation.

In some embodiments, a disclosed system may utilize a trained machine learning model to capture anomalous transactions unblocked by humans, e.g. store associates and/or retailer principles. Training the machine learning model using various anomaly indicators may enable the machine learning model to learn from more anomaly patterns and effectively block any fraudster, e.g., even when untrained store associates come in or when principle declines are down.

In some examples, during a training stage of the machine learning model, the system can categorize denied transactions into a plurality of anomaly tiers based on their likelihoods of being real anomalies. The system may train the machine learning model based at least in part by optimizing an objective function characterizing a plurality of objectives at the same time in one iteration, without a need to optimize different objectives in multiple iterations based on binary classification for each objective. Each of the plurality of objectives corresponds to an optimization over transactions in a corresponding one of the plurality of anomaly tiers.

In some examples, during an inference stage of the machine learning model, the system can utilize the trained machine learning model to determine a risk score based on feature data of a pending transaction. In some embodiments, the feature data may comprise at least one of: a feature associated with a sender of the pending transaction; a feature associated with a receiver of the pending transaction; a distance between the sender and receiver; or a frequency of transactions from the sender in a past time period. Based on the feature data, the system may classify the pending transaction into a corresponding risk group of a plurality of risk groups. The plurality of risk groups can be associated with different risk thresholds respectively. The system may compare the risk score of the pending transaction to a risk threshold associated with the corresponding risk group. When the risk score is higher than the risk threshold, the system may generate and transmit recommendation data to deny the pending transaction. When the risk score is not higher than the risk threshold, the system may generate and transmit recommendation data to accept the pending transaction.

In various embodiments, a system including a processor and a non-transitory memory storing instructions is disclosed. The instructions, when executed, cause the processor to: receive a risk assessment request regarding a transaction; generate feature data based on the risk assessment request; determine, using a machine learning model, a risk score based on the feature data, wherein the machine learning model is trained based on an objective function characterizing a plurality of objectives; generate recommendation data regarding the transaction based on the risk score; and transmit the recommendation data to a computing device.

In various embodiments, a computer-implemented method is disclosed. The computer-implemented method includes: receiving a risk assessment request regarding a transaction; generating feature data based on the risk assessment request; determining, using a machine learning model, a risk score based on the feature data, wherein the machine learning model is trained based on an objective function characterizing a plurality of objectives; generating recommendation data regarding the transaction based on the risk score; and transmitting the recommendation data to a computing device.

In various embodiments, a non-transitory computer readable medium having instructions stored thereon is disclosed. The instructions, when executed by at least one processor, cause at least one device to perform operations including: receiving a risk assessment request regarding a transaction; generating feature data based on the risk assessment request; determining, using a machine learning model, a risk score based on the feature data, wherein the machine learning model is trained based on an objective function characterizing a plurality of objectives; generating recommendation data regarding the transaction based on the risk score; and transmitting the recommendation data to a computing device.

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

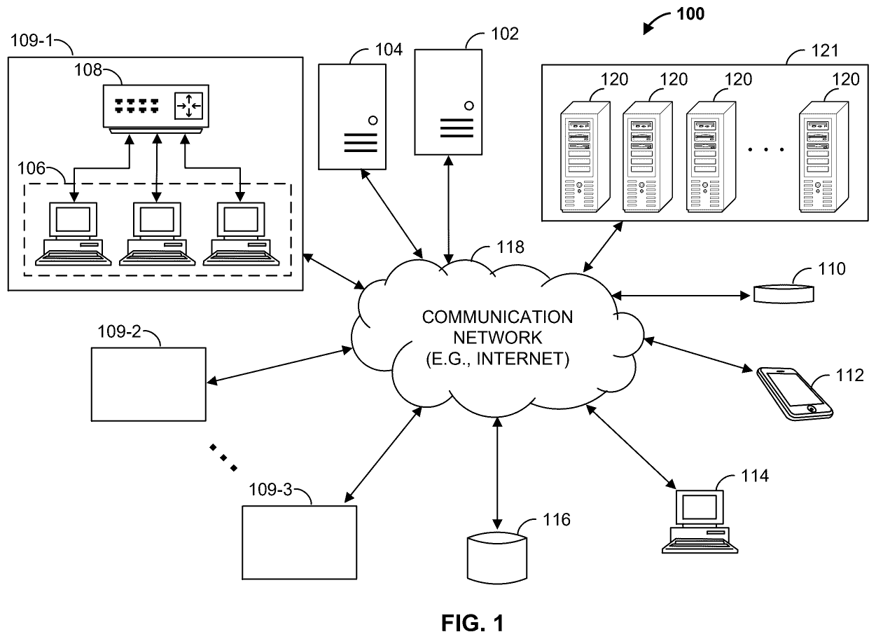

Turning to the drawings, FIG. 1 is a network environment 100 configured for anomaly detection using machine learning, in accordance with some embodiments. The network environment 100 includes a plurality of devices or systems that can communicate over one or more network channels, illustrated as a network cloud 118. For example, in various embodiments, the network environment 100 can include, but not limited to, an anomaly detection computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The anomaly detection computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the anomaly detection computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more Tensor Processing Units (TPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the anomaly detection computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the anomaly detection computing device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 can communicate with the anomaly detection computing device 102 over the communication network 118. The workstation(s) 106 may send data to, and receive data from, the anomaly detection computing device 102. For example, the workstation(s) 106 may transmit data identifying transactions, inventory, assortment, supply chain data and/or waste data at the one or more fulfillment nodes 109 to the anomaly detection computing device 102. The workstation(s) 106 may also transmit other data related to the one or more fulfillment nodes 109 to the anomaly detection computing device 102.

Although FIG. 1 illustrates three user computing devices 110, 112, 114, the network environment 100 can include any number of user computing devices 110, 112, 114. Similarly, the network environment 100 can include any number of the anomaly detection computing devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the anomaly detection computing device 102 over the communication network 118. The website may also allow the customer to add one or more of the items to an online shopping cart, and allow the customer to perform a “checkout” of the shopping cart to purchase the items. In some examples, the server 104 transmits purchase data identifying items the customer has purchased from the website to the anomaly detection computing device 102.

In some examples, the server 104 transmits a risk assessment request to the anomaly detection computing device 102. The risk assessment request may be sent regarding a pending transaction of an online user. For example, the online user submits an order for an item on a website hosted by the server 104, e.g. by clicking on the item to view its product description details, by adding it to a shopping cart, and by placing an order with a payment method. In some examples, the risk assessment request may be sent regarding a pending money transfer from a sender to a receiver. The server 104 may generate and send the risk assessment request to the anomaly detection computing device 102 to evaluate a risk degree of the pending transaction being an anomaly.

In some examples, the anomaly detection computing device 102 receives a risk assessment request from one node (e.g. a store 109-1) of the nodes 109. The risk assessment request may be sent regarding a pending transaction of an in-store user at the store 109-1. For example, the in-store user may try to check out an order for an item in the store using a payment method, e.g. a credit card. The store 109-1 may generate and send the risk assessment request to the anomaly detection computing device 102 to evaluate a risk degree of the pending transaction being an anomaly.

In any one of the above examples, the anomaly detection computing device 102 may generate feature data based on the risk assessment request. For example, the feature data may comprise: a feature associated with a sender of the transaction, a feature associated with a receiver of the transaction, a distance between the sender and receiver (e.g. based on a postal code distance, a store distance, etc.), and/or a frequency of transactions from the sender in a past time period. Using a machine learning model, the anomaly detection computing device 102 can determine a risk score based on the feature data. The machine learning model may be trained based on an objective function characterizing a plurality of objectives. The anomaly detection computing device 102 can then generate recommendation data regarding the transaction based on the risk score, and transmit the recommendation data to the server 104 or one of the nodes 109. The transaction will be granted or denied based on the recommendation data.

In some embodiments, the anomaly detection computing device 102 is further operable to communicate with the database 116 over the communication network 118. For example, the anomaly detection computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the anomaly detection computing device 102, in some examples, the database 116 can be a local storage device, such as a hard drive, a non-volatile memory, or a USB stick. For example, the anomaly detection computing device 102 may store online purchase data and transaction data of a receiver and a sender regarding a money transfer service, received from the server 104, in the database 116. The anomaly detection computing device 102 may receive in-store purchase data, transaction data of receiver and sender of a money transfer service, and node related data from different nodes 109 and store them in the database 116. The anomaly detection computing device 102 may also receive from the server 104 user session data identifying events associated with browsing sessions of receiver and sender of a money transfer service, and may store the user session data in the database 116. The anomaly detection computing device 102 may also compute recommendation data in response to a risk assessment request received from the server 104 (or the nodes 109), and may store the recommendation data in the database 116.

In some examples, the anomaly detection computing device 102 generates and/or updates different models (e.g., machine learning models, deep learning models, statistical models, algorithms, natural language models, etc.) for anomaly detection. The anomaly detection computing device 102 may generate training data for the models based on data including but not limited to: item features, user history data, historical sale data, historical risk assessment data, and historical anomaly report data. The anomaly detection computing device 102 trains the models based on their corresponding training data, and stores the models in a database, such as in the database 116 (e.g., a cloud storage). The models, when executed by the anomaly detection computing device 102, allow the anomaly detection computing device 102 to generate recommendation data for assessing risks of pending transactions.

In some examples, the anomaly detection computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the anomaly detection computing device 102 may generate recommendation data for assessing risks of pending transactions.

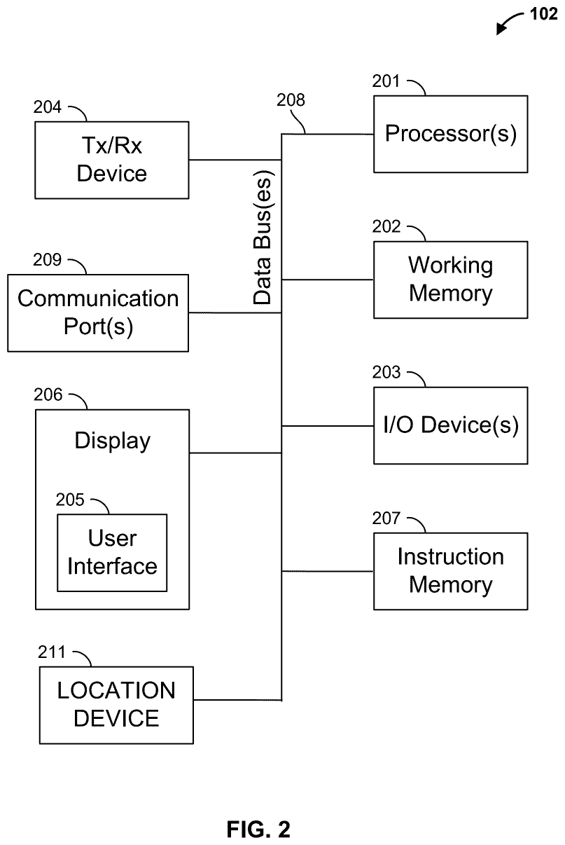

FIG. 2 illustrates a block diagram of an anomaly detection computing device, e.g. the anomaly detection computing device 102 of FIG. 1, in accordance with some embodiments. In some embodiments, each of the anomaly detection computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the anomaly detection computing device 102 can be combined, omitted, and/or replicated. In addition, it will be appreciated that additional elements other than those illustrated in FIG. 2 can be added to the anomaly detection computing device 102.

As shown in FIG. 2, the anomaly detection computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the anomaly detection computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the anomaly detection computing device 102 can include a single memory unit to operate as both instruction memory and working memory. Further, although embodiments are discussed herein including non-volatile memory, it will be appreciated that the anomaly detection computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 allows communications with the cellular network. In some embodiments, the transceiver 204 is selected based on the type of the communication network 118 the anomaly detection computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the anomaly detection computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 may couple the anomaly detection computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the anomaly detection computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the anomaly detection computing device 102 may determine a local geographical area (e.g., town, city, state, etc.) of its position.

In some embodiments, the anomaly detection computing device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

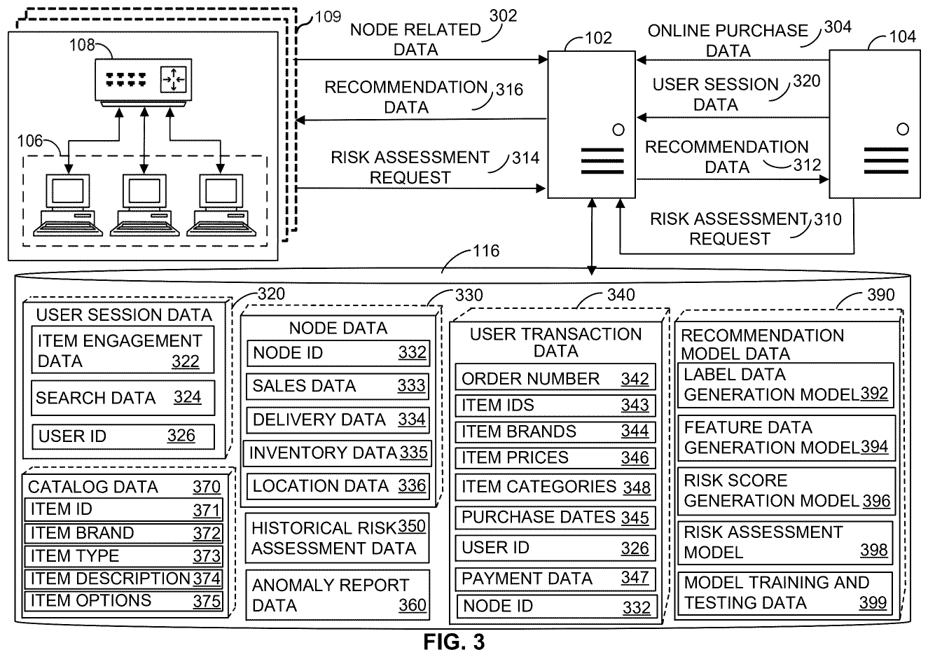

FIG. 3 is a block diagram illustrating various portions of a system for anomaly detection using machine learning, e.g. the system shown in the network environment 100 of FIG. 1, in accordance with some embodiments. As indicated in FIG. 3, the anomaly detection computing device 102 may receive user session data 320 from the server 104, and store the user session data 320 in the database 116. The user session data 320 may identify, for each user (e.g., customer, seller, associate), data related to that user's browsing session, such as when browsing a retailer's webpage hosted by the server 104. In some embodiments, the system may not utilize all of the components and data shown in FIG. 3 for recommending and optimizing inventory target levels for items.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items viewed by the user, items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The anomaly detection computing device 102 may also receive online purchase data 304 from the server 104, which identifies and characterizes one or more online purchases, such as purchases made by the user and other users via a retailer's website hosted by the server 104. The anomaly detection computing device 102 may also receive node related data 302 from the fulfillment nodes 109, which identifies and characterizes one or more in-store purchases, product location data, inventory data, and/or assortment data related to each of the fulfillment nodes 109. In some embodiments, the node related data 302 may also indicate other information about the fulfillment nodes 109. In some embodiments, the fulfillment nodes 109 and the server 104 are associated with each other such that the online purchase data 304, the user session data 320 and the node related data 302 all come from a same server cluster or datacenter.

The anomaly detection computing device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some examples, the anomaly detection computing device 102 receives a risk assessment request 310 regarding a corresponding transaction submitted by a customer interacting with a website hosted by the server 104. In some examples, the risk assessment request 310 may be embedded in the online purchase data 304 without being separately sent or identified. The user session data 320 itself can also serve as a risk assessment request. In response, the anomaly detection computing device 102 may generate feature data of the corresponding transaction, and determine a risk score using a machine learning model based on the feature data. In some embodiments, the machine learning model is trained based on an objective function characterizing a plurality of objectives. The anomaly detection computing device 102 may generate recommendation data 312 regarding the corresponding transaction based on the risk score, and transmit the recommendation data 312 to the server 104.

In some examples, the anomaly detection computing device 102 receives a risk assessment request 314 regarding a corresponding transaction submitted by a customer shopping at a node (e.g. a store) 109. In some examples, the risk assessment request 314 may be embedded in the node related data 302 without being separately sent or identified. In response, the anomaly detection computing device 102 may generate feature data of the corresponding transaction, and determine a risk score using a machine learning model based on the feature data. In some embodiments, the machine learning model is trained based on an objective function characterizing a plurality of objectives. The anomaly detection computing device 102 may generate recommendation data 316 regarding the corresponding transaction based on the risk score, and transmit the recommendation data 316 to the node 109.

In some embodiments, the anomaly detection computing device 102 may generate node data 330 based on the node related data 302. In some examples, the node data 330 may include, for each node, one or more of: the node ID 332 of the node, sales data 333 indicating data of historical sales for each item in the node, delivery data 334 indicating data of historical deliveries of each item to and from the node, inventory data 335 identifying and charactering an inventory status for each item in the node, and location data 336 identifying a location of the node.

In some examples, the database 116 may also store historical risk assessment data 350 identifying historical risk assessments of transactions or money transfers. In some examples, the database 116 may also store anomaly report data 360 identifying reports of previously detected anomalies.

The database 116 may also store recommendation model data 390 identifying and characterizing one or more models and related data for anomaly detection using machine learning. For example, the recommendation model data 390 may include: a label data generation model 392, a feature data generation model 394, a risk score generation model 396, a risk assessment model 398 and model training and testing data 399. In various embodiments, the recommendation model data 390 includes any number of the label data generation models 392, the feature data generation models 394, the risk score generation models 396, and the risk assessment models 398.

The label data generation model 392 in some examples can be used to generate a label data set based on data associated with a plurality of transactions. For each respective transaction of the plurality of transactions, the label data generation model 392 can be used to determine whether the respective transaction is accepted or denied. In accordance with a determination that the respective transaction is accepted, the label data generation model 392 may be used to generate a non-anomaly label to identify the respective transaction as a non-anomaly transaction. In accordance with a determination that the respective transaction is denied, the label data generation model 392 may be used to determine whether there is a later transaction that: (1) is accepted within a predetermined time period after the respective transaction is denied and (2) has a same transaction amount, a same sender and a same receiver as the respective transaction. In accordance with a determination that there is such later transaction, the label data generation model 392 may be used to generate a non-anomaly label to identify the respective transaction as a non-anomaly transaction. In accordance with a determination that there is no such later transaction, the label data generation model 392 may be used to generate an anomaly label to identify the respective transaction as an anomaly transaction. In some examples, for each anomalous transaction identified from the plurality of transactions, the label data generation model 392 may be used to determine at least one reason that the anomalous transaction is denied, and categorize the anomalous transaction into at least one of a plurality of anomaly tiers based on the at least one reason. The plurality of anomaly tiers correspond to different likelihoods for an anomalous transaction to be a real anomaly.

The feature data generation model 394 in some examples can be used to generate a feature data set based on the label data set generated by the label data generation model 392 and the data associated with the plurality of transactions. In some examples, the feature data generation model 394 may be used to: simulate a plurality of features related to the plurality of transactions; and remove, from the plurality of features, redundant features whose correlations to a given feature are higher than a threshold, to generate a filtered set of features. From the filtered set of features, the feature data generation model 394 may be used to select at least one feature whose information value with respect to labels in the label data set is higher than a threshold. The feature data set may be generated based on the selected at least one feature.

The risk score generation model 396 in this example can be used to generate a risk score regarding a transaction based on feature data of the transaction. The risk score may represent a degree of likelihood that the transaction is an anomaly. In some embodiments, the risk score generation model 396 is a machine learning model trained based on a training data set. In some examples, the training data set may comprise: the label data set generated by the label data generation model 392, the feature data set generated using the feature data generation model 394, and an objective function characterizing a plurality of objectives. In some embodiments, the risk score generation model 396 may be trained based on the training data set by optimizing the objective function. In some examples, the objective function may comprise a weighted combination of binary indications, each of which indicates whether a transaction is categorized into a corresponding one of a plurality of anomaly tiers. Each of the plurality of objectives may correspond to an optimization over transactions in a corresponding one of the plurality of anomaly tiers.

In some embodiments, the risk score generation model 396 may be trained further based on: tuning the objective function by changing at least one weight in the objective function to generate an updated objective function; generating an updated training data set based on the feature data set, the label data set and the updated objective function; and re-training the machine learning model based on the updated training data set by optimizing the updated objective function.

The risk assessment model 398 in this example can be used to generate recommendation data regarding a transaction based on the risk score generated by the risk score generation model 396. In some examples, the recommendation data may include either a recommendation to accept the transaction, or a recommendation to deny the transaction with a code representing a reason for denying the transaction. In some embodiments, the risk assessment model 398 may be used to classify, based on the feature data of the transaction, the transaction into a risk group of a plurality of risk groups. The plurality of risk groups are associated with different risk thresholds respectively. The risk assessment model 398 may be used to compare the risk score to a risk threshold associated with the risk group. The recommendation data may be generated to deny the transaction when the risk score is higher than the risk threshold, and to accept the transaction when the risk score is not higher than the risk threshold.

In some embodiments, one or more of the label data generation model 392, the feature data generation model 394, the risk score generation model 396 and the risk assessment model 398 can be implemented as a machine learning model, a deep learning model, a neural network or a large language model. The model training and testing data 399 may include data utilized for training one or more of the label data generation model 392, the feature data generation model 394, the risk score generation model 396 and the risk assessment model 398. In some examples, the model training and testing data 399 may be formed based on: item features, user features, historical or labelled sale data, historical or labelled risk assessment data, historical or labelled anomaly report data, and historical feedback data, obtained from either real data or synthetic data.

In some embodiments, the anomaly detection computing device 102 may assign one or more of the above described operations to a different processing unit or virtual machine hosted by one or more processing devices 120. Further, the anomaly detection computing device 102 may obtain the outputs of these assigned operations from the processing units, and generate the recommendation data 312 or the recommendation data 316 based on the outputs.

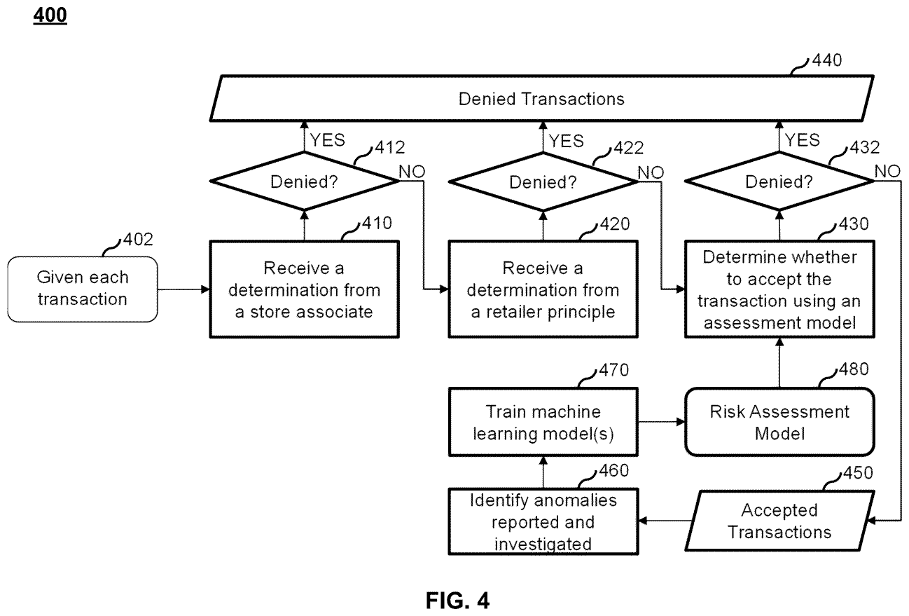

FIG. 4 illustrates an example process 400 for managing transactions based on anomaly risks, in accordance with some embodiments. In some embodiments, the process 400 can be implemented by one or more computing devices, such as the anomaly detection computing device 102 and/or the cloud-based engine 121 of FIG. 1.

In some embodiments, the process 400 may be used to assess anomaly risks of a plurality of transactions associated with a retailer, and classify each of the plurality of transactions as a denied transaction or an accepted transaction. As shown in FIG. 4, the process 400 in this example starts from operation 410, where given each transaction 402, a determination is received from a store associate regarding whether to accept the transaction. In some embodiments, the store associate is an associate of the retailer located at a store where an order of the transaction is placed.

At operation 412, it is determined whether the transaction is to be denied or not based on the determination received from the store associate. If so, the transaction is denied and classified as one of the denied transactions 440. If not, at operation 420, a determination is received from a retailer principle regarding whether to accept the transaction. In some embodiments, the retailer principle is a principle of the retailer who has more experience and resources for anomaly risk evaluation than the store associate.

At operation 422, it is determined whether the transaction is to be denied or not based on the determination received from the retailer principle. If so, the transaction is denied and classified as one of the denied transactions 440. If not, it is determined at operation 430 using an assessment model whether to accept the transaction.

At operation 432, it is determined whether the transaction is to be denied or not based on the determination using the assessment model. If so, the transaction is denied and classified as one of the denied transactions 440. If not, the transaction is accepted and classified as one of the accepted transactions 450.

In the example shown in FIG. 4, the assessment model is a risk assessment model 480. In some embodiments, the risk assessment model 480 is a machine learning model trained based on a training dataset. In some examples, the operation 430 may be performed during an on-line inference stage of the risk assessment model 480, while operations 460 and 470 may be performed during an off-line training stage of the risk assessment model 480.

At operation 460, anomalous transaction data can be identified from some of historically accepted transactions 450. During the off-line training stage, the historically accepted transactions 450 may include some anomalous transactions that were not captured by the operations 410~430 during a previous on-line inference stage. The anomalous transaction data identified at the operation 460 may indicate anomalous transactions, each of which being either an anomalous transaction reported by a corresponding fraud victim or an anomalous transaction determined by an expert investigation. In some examples, the victim-reported anomalies and the expert-investigated anomalies typically need a long time to be identified, and thus cannot be determined in real time for pending transactions.

At operation 470, one or more machine learning models, e.g. the risk assessment model 480, is trained based on a training dataset. The training dataset may be generated based on the anomalous transaction data identified at the operation 460. For example, the training dataset may be generated to include features and labels of the anomalous transactions indicated by the anomalous transaction data. In some examples, the training dataset may also include an objective function characterizing a plurality of objectives to be optimized by the risk assessment model 480 during the off-line training stage.

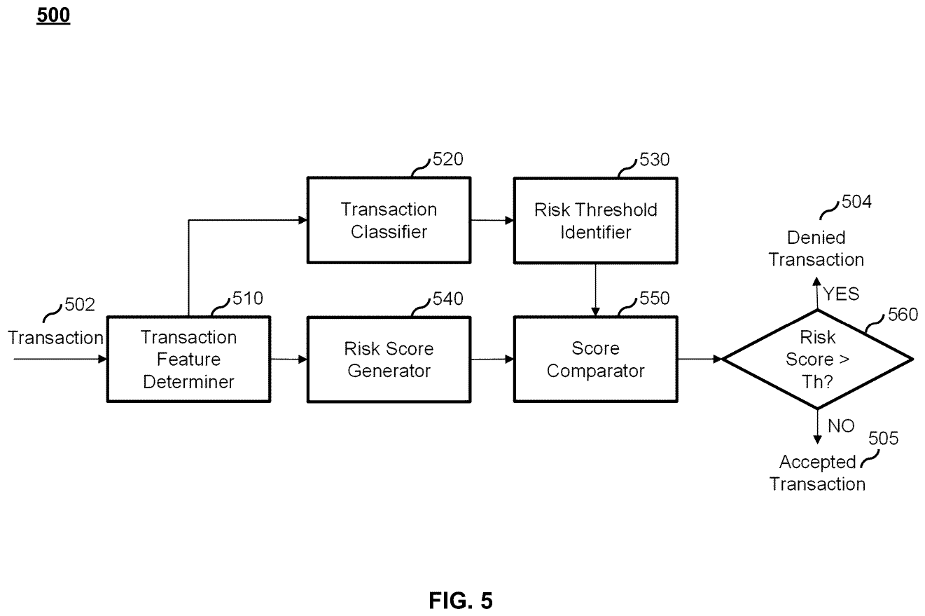

FIG. 5 is a block diagram illustrating various portions of a system 500 to accept or deny a transaction automatically based on a machine learning model, in accordance with some embodiments. In some embodiments, the system 500 can be implemented by one or more computing devices, such as the anomaly detection computing device 102 and/or the cloud-based engine 121 of FIG. 1. In some embodiments, the system 500 can perform the operation 430 in FIG. 4 with details.

As shown in FIG. 5, the system 500 in this example includes a transaction feature determiner 510, a transaction classifier 520, a risk threshold identifier 530, a risk score generator 540 and a score comparator 550. In some examples, given a transaction 502, the transaction feature determiner 510 can generate feature data of the transaction 502 for risk assessment, e.g. for an evaluation of anomaly risk of the transaction 502. In some examples, the transaction 502 may be a transaction ordered by a user and/or a transaction having been accepted based on human decisions (e.g. by decisions of a store associate and a retailer principle). In some examples, the feature data may comprise at least one of: a feature associated with a sender of the transaction 502; a feature associated with a receiver of the transaction 502; a distance between the sender and receiver; or a frequency of transactions from the sender in a past time period. The transaction feature determiner 510 may send the feature data to the transaction classifier 520 for transaction classification and send the feature data to the risk score generator 540 for risk score generation.

Based on the feature data, the transaction classifier 520 in some examples can classify the transaction 502 into a corresponding risk group of a plurality of risk groups. The plurality of risk groups may be associated with different risk thresholds respectively. For example, there are n risk groups, where risk group 1 is associated with a risk threshold t₁, risk group 2 is associated with a risk threshold t₂ . . . risk group n is associated with a risk threshold tₙ.

In some examples, different risk groups have different risk tiers or seriousness tiers, e.g. ordered from t₁ to tₙ. For example, transactions assigned to the risk group 1 may have a higher risk of being anomaly (or a more serious impact if being anomaly) compared to transactions assigned to the risk group 2. Accordingly, the risk threshold t₁ may be lower than the risk threshold t₂, such that the risk group 1 can have a higher denial rate compared to the risk group 2. In some examples, a definite value of a risk threshold for each risk group may be dynamically changed based on a desired decline rate for transactions in the risk group according to some business requirements or user feedback. In some examples, a total number of risk groups may also be dynamically changed based on business requirements or user feedback.

In some examples, the transaction classifier 520 may determine a risk tier for the transaction 502 based on the feature data (e.g. transaction type, transaction amount, sender location, receiver location, etc.) of the transaction 502 determined by the transaction feature determiner 510, and assign the transaction classifier 520 into the corresponding risk group. The risk threshold identifier 530 may identify a risk threshold associated with the corresponding risk group determined by the transaction classifier 520. In some examples, the risk threshold identifier 530 may send the risk threshold to the score comparator 550 for risk score comparison.

The risk score generator 540 in this examples may determine a risk score based on the feature data of the transaction 502 determined by the transaction feature determiner 510. The risk score may represent a degree of likelihood that the transaction 502 is an anomaly. In some embodiments, the risk score is generated by the risk score generator 540 using a machine learning model, e.g. the risk score generation model 396 in FIG. 3. The machine learning model may be trained based on an objective function characterizing a plurality of objectives. In some examples, the risk score generator 540 may send the risk score to the score comparator 550 for risk score comparison.

The score comparator 550 in this examples may receive the risk score generated by the risk score generator 540, and receive the risk threshold identified by the risk threshold identifier 530. The score comparator 550 can compare the risk score of the transaction 502 to the risk threshold associated with a risk group the transaction 502 belongs to. Based on a determination 560 of whether the risk score is higher than the risk threshold, the transaction 502 is determined to be either a denied transaction 504 or an accepted transaction 505.

The system 500 may generate recommendation data regarding the transaction 502 based on the comparison by the score comparator 550, and transmit the recommendation data to a computing device to deny or accept the transaction 502. In some examples, when the risk score is not higher than the risk threshold, the system 500 may generate recommendation data to accept the transaction 502. The recommendation data may include a recommendation to accept the transaction 502. In some examples, when the risk score is higher than the risk threshold, the system 500 may generate recommendation data to deny the transaction 502. The recommendation data may include: a recommendation to deny the transaction 502 and a code representing a reason for denying the transaction 502. The reason may correspond to one or more features of the transaction 502 that contribute the most to the risk score generated by the risk score generator 540. The one or more features may be determined by the risk score generator 540 during the risk score generation.

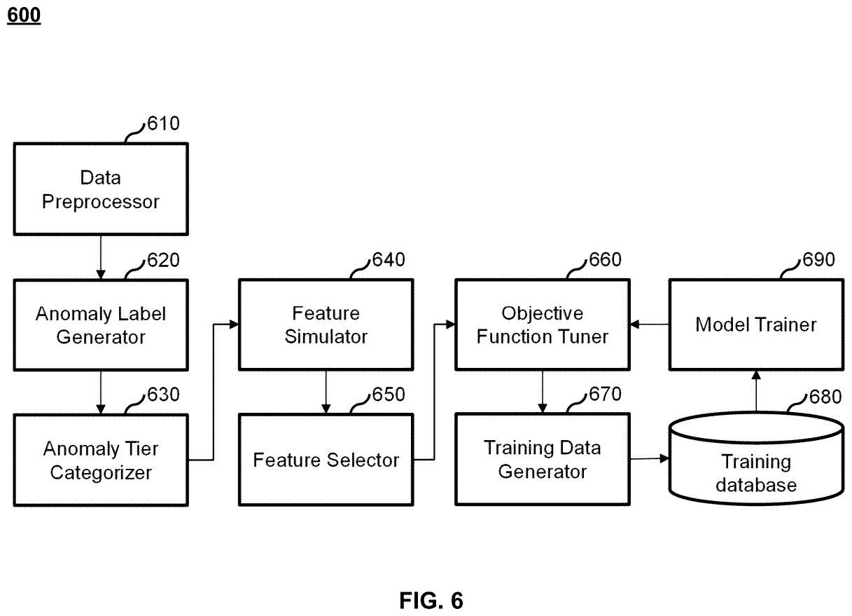

FIG. 6 is a block diagram illustrating various portions of a system 600 to train a machine learning model for anomaly detection, in accordance with some embodiments. In some embodiments, the system 600 can be implemented by one or more computing devices, such as the anomaly detection computing device 102 and/or the cloud-based engine 121 of FIG. 1. In some embodiments, the system 600 can perform the operation 470 in FIG. 4 with details.

As shown in FIG. 6, the system 600 in this example includes a data preprocessor 610, an anomaly label generator 620, an anomaly tier categorizer 630, a feature simulator 640, a feature selector 650, an objective function tuner 660, a training data generator 670 and a model trainer 690. In some examples, the data preprocessor 610 can obtain data associated with a plurality of transactions, and processing the data. The data processing performed by the data preprocessor 610 may include: removing noises, removing outliers, and/or converting the data into a standardized data format. In some examples, the plurality of transactions includes anomalous transactions identified by the operation 460 in FIG. 4. For example, the plurality of transactions may include anomalous transactions reported by corresponding fraud victims or determined by human investigations. In some examples, the plurality of transactions may also include some denied transactions, e.g. from the denied transactions 440. In some examples, the plurality of transactions may also include non-anomaly transactions.

The anomaly label generator 620 in some examples can generate a label data set based on the data associated with the plurality of transactions obtained by the data preprocessor 610. For each respective transaction of the plurality of transactions, the anomaly label generator 620 may generate an anomaly label or non-anomaly label. For example, the anomaly label generator 620 can determine whether the respective transaction is anomaly or non-anomaly. In accordance with a determination that the respective transaction is accepted, the anomaly label generator 620 may generate a non-anomaly label to identify the respective transaction as a non-anomaly transaction.

In accordance with a determination that the respective transaction is denied, the anomaly label generator 620 may determine whether there is a later transaction that: (1) is accepted within a predetermined time period after the respective transaction is denied and (2) has a same transaction amount, a same sender and a same receiver as the respective transaction. In accordance with a determination that there is such later transaction, the anomaly label generator 620 may generate a non-anomaly label to identify the respective transaction as a non-anomaly transaction. In accordance with a determination that there is no such later transaction, the anomaly label generator 620 may generate an anomaly label to identify the respective transaction as an anomaly transaction.

As such, the anomaly label generator 620 may apply some follow-on logic to remove false positive denied transactions. For example, after an original transaction is stopped or denied, if a follow-on transaction with the same amount, same sender and same receiver is executed within 24 hours, and if the follow-on transaction is then approved, the original transaction is not labeled as non-anomaly.

For each anomaly transaction identified from the plurality of transactions by the anomaly label generator 620, the anomaly tier categorizer 630 in some examples can categorize the anomaly transaction into an anomaly tier. In some embodiments, the anomaly tier categorizer 630 may determine decline reasons based on data sent by the anomaly label generator 620 or written by a store associate or a retailer principle. Based on the decline reasons, the anomaly tier categorizer 630 can categorize the anomaly transaction into at least one of a plurality of anomaly tiers. The plurality of anomaly tiers may correspond to different likelihoods for an anomaly transaction to be a real anomaly.

In some examples, each anomaly transaction or denied transaction may be categorized into one of four different tiers: Tier 1, Tier 2, Tier 3, Tier 4, ordered from most likely to be a real anomaly to least likely to be a real anomaly. The categorization may be performed based on the reasons for the anomaly transactions being denied or declined. For example, a store associate or a retailer principle may specify a reason to deny or decline a transaction, e.g. the sender does not know the receiver, or the sender did not approve the transaction using a payment method associated with the sender. The anomaly label generator 620 may also generate a reason for labeling a transaction as anomaly, e.g. reported as scam by a victim, or determined by an investigation of an expert. In some examples, Tier 1 may include transactions that have been reported as anomaly by victims. The tier logic of the different tiers may be confirmed by testing data, e.g. false positive rates. For example, Tier 1 may be confirmed to have a higher anomaly rate or a less false positive rate than Tier 2.

The feature simulator 640 in some examples can simulate a plurality of features related to the plurality of transactions, e.g. based on data obtained by the data preprocessor 610 associated with the plurality of transactions. In some examples, the features may comprise: features of the items involved in the plurality of transactions, features of receivers of the plurality of transactions, features of senders of the plurality of transactions, features related to both receivers and senders, features related to payment methods of the plurality of transactions, money amount ranges of the plurality of transactions, etc.

The feature selector 650 in some examples can generate a feature data set based on the label data set generated by the anomaly label generator 620 and the plurality of features simulated by the feature simulator 640. In some examples, the feature selector 650 may remove, from the plurality of features, one or more redundant features whose correlations to a given feature are higher than a threshold, to generate a filtered set of features. From the filtered set of features, the feature selector 650 can select at least one feature whose information value with respect to labels in the label data set is higher than a threshold. A feature having a higher information value with respect to a target label has a higher importance or higher correlation to the target label, compared to other features having lower information values with respect to the target label. As such, features with high information values can be selected by the feature selector 650 as features highly predictive of the corresponding target labels. The feature selector 650 may generate the feature data set based on the selected at least one feature. In some examples, the feature selector 650 may select features like: a feature associated with a sender of a transaction; a feature associated with a receiver of a transaction; a distance between the sender and receiver (e.g. a distance between a state of the sender's address and a state of the receiver's address, international transaction or not, etc.); and/or a frequency of transactions from the sender in a past time period (e.g. a number of transactions associated with the sender's ID in the past ten days, whether the sender is a new customer, any recent transactions, etc.).

In some embodiments, the objective function tuner 660 can determine or tune an objective function characterizing a plurality of objectives. In some examples, the objective function may comprise a weighted combination of binary indications. Each binary indication may indicate whether a transaction is categorized into a corresponding one of the plurality of anomaly tiers. Each of the plurality of objectives corresponds to an optimization over transactions in a corresponding one of the plurality of anomaly tiers.

In some examples, all denied transactions are categorized into one of four different anomaly tiers: Tier 1, Tier 2, Tier 3, Tier 4, ordered from most likely to be a real anomaly to least likely to be a real anomaly. The four different anomaly tiers Tier 1, Tier 2, Tier 3 and Tier 4 are associated with four binary indications T1, T2, T3 and T4, respectively, and are associated with weights w1, w2, w3 and w4, respectively to form an objective function: w1*T1+w2*T2+w3*T3+w4*T4.

In some examples, the objective function tuner 660 can determine the objective function by determining the weights in the objective function. The training data generator 670 may generate a training data set based on the feature data set generated by the feature selector 650, the label data set generated by the anomaly label generator 620 and the objective function determined by the objective function tuner 660. The training data generator 670 may store the training data set into a training database 680, which may be part of the database 116 or a standalone database.

During a training stage, the model trainer 690 may train a machine learning model based on the training data set by optimizing the objective function. For example, the machine learning model may be the risk score generation model 396 in FIG. 3 or the risk assessment model 480 in FIG. 4. In some examples, the training data set may be further split into 70% training data and 30% testing and validation data. The training data is used to train the machine learning model. The testing and validation data are used to evaluate and validate the performance of the machine learning model.

In some examples, the objective function tuner 660, the training data generator 670 and the model trainer 690 may perform iterations to train and optimize the machine learning model. In each iteration, the objective function tuner 660 may tune the objective function by changing at least one weight in the objective function to generate an updated objective function. The tuning may be performed based on a feedback from the model trainer 690, e.g. based on a difference between a candidate risk score generated by the machine learning model and a target risk score computed using the objective function during last iteration. The training data generator 670 in current iteration may generate an updated training data set based on the feature data set generated by the feature selector 650, the label data set generated by the anomaly label generator 620 and the updated objective function determined by the objective function tuner 660. The model trainer 690 may re-train the machine learning model based on the updated training data set by optimizing the updated objective function. The iterations may stop and the machine learning model may be well trained, when a criterion is met. For example, the iterations may stop when an average difference, between candidate risk scores generated by the machine learning model and target risk scores computed using the objective function for the plurality of transactions, is less than a threshold. In some examples, the iterations may stop when the average difference stops becoming smaller after a certain time of iterations.

In the above example regarding four different anomaly tiers Tier 1, Tier 2, Tier 3 and Tier 4, their associated weights w1, w2, w3 and w4 may be first initialized as 4, 3, 2 and 1, respectively to form an objective function: 4*T1+3*T2+2*T3+1*T4. In some examples, the initial weights may be determined by training a machine learning model for each individual objective T1, T2, T3, T4, respectively. In one example, if a transaction is categorized merely into Tier 2, its corresponding objective function would be 4*0+3*1+2*0+1*0=3. The goal of training the machine learning model at current iteration would be to find optimal model parameters for the machine learning model to generate a risk score based on selected features of the transaction, such that the risk score generated by the machine learning model is as close to the objective function output, i.e. 3 here, as possible. In some examples, at next iteration, one or more of the weights may be tuned, based on risk score generation and optimization for not only this transaction but also other transactions. For example, the objective function may be updated at next iteration to: 5*T1+3.5*T2+1.5*T3+1*T4. Accordingly, the same transaction would have a corresponding objective function output of 5*0+3.5*1+1.5*0+1*0=3.5 at next iteration. The goal of training the machine learning model at next iteration would be to find optimal model parameters for the machine learning model to generate a risk score based on selected features of the transaction, such that the risk score generated by the machine learning model is as close to the objective function output, i.e. 3.5 here, as possible.

In some embodiments, the tuning of the weights at each iteration is subject to some constraints. In some examples, because the four anomaly tiers Tier 1, Tier 2, Tier 3 and Tier 4 are ordered from most likely to be a real anomaly to least likely to be a real anomaly, their associated weights w1, w2, w3 and w4 must satisfy w1>=w2>=w3>=w4, before and after the tuning.

In some examples, a transaction may be categorized into multiple anomaly tiers at the same time based on its transaction features, e.g. categorized into both Tier 1 and Tier 4. Then the transaction would have a corresponding objective function as 4*1+3*0+2*0+1*1=5.

In some examples, the objective function tuner 660, the training data generator 670 and the model trainer 690 may perform the iterations to find optimal model parameters for each iteration to minimize the average difference. In some examples, the machine learning model is a regression model (e.g. a random forest regression model), and the model parameters to be optimized for each iteration may include: a maximum depth of a tree, a subsample ratio of the training instances, a step size shrinkage used in update to prevent overfitting of merely existing samples, a specified column subsampling rate per tree, a specified number of trees to build, etc.

As such, the system 600 may adopt a multi-objective optimization method to automatically select the most appropriate weights to different anomaly tiers. While different anomaly tiers may have different anomaly certainty levels and different anomaly patterns, the disclosed multi-objective optimization can come up with one balanced objective incorporating a variety of anomaly patterns and anomaly certainty levels. The multi-objective optimization can tune and test all weights in the objective function by one iteration. The multi-objective optimization can perform well across all transactions through all objectives, and perform well through each individual objective at the same time.

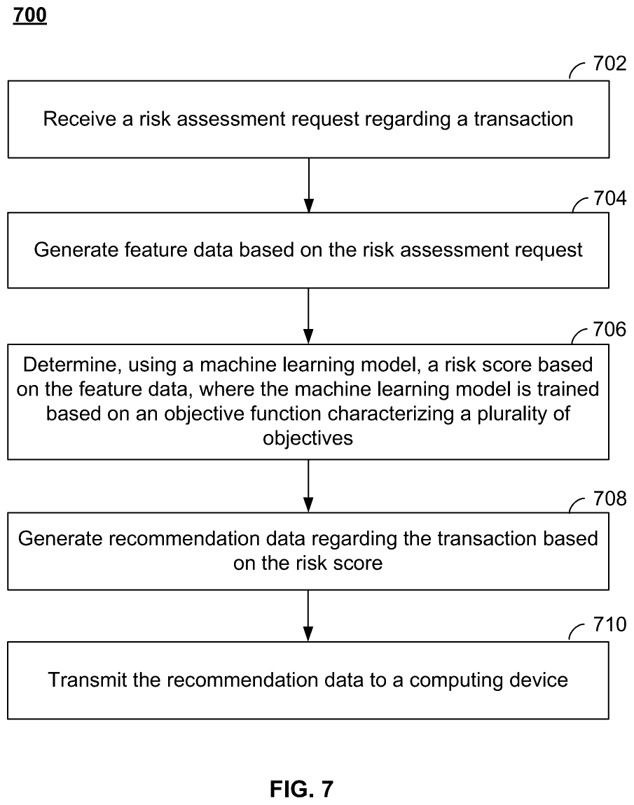

FIG. 7 shows a flowchart illustrating an example method 700 for anomaly detection using machine learning, in accordance with some embodiments. In some embodiments, the method 700 can be carried out by a system including one or more computing devices, such as the anomaly detection computing device 102 and/or the cloud-based engine 121 of FIG. 1. Beginning at operation 702, a risk assessment request regarding a transaction is received. At operation 704, feature data is generated based on the risk assessment request. At operation 706, using a machine learning model, a risk score may be determined based on the feature data. The machine learning model may be trained based on an objective function characterizing a plurality of objectives. At operation 708, recommendation data regarding the transaction is generated based on the risk score. The recommendation data is transmitted at operation 710 to a computing device.

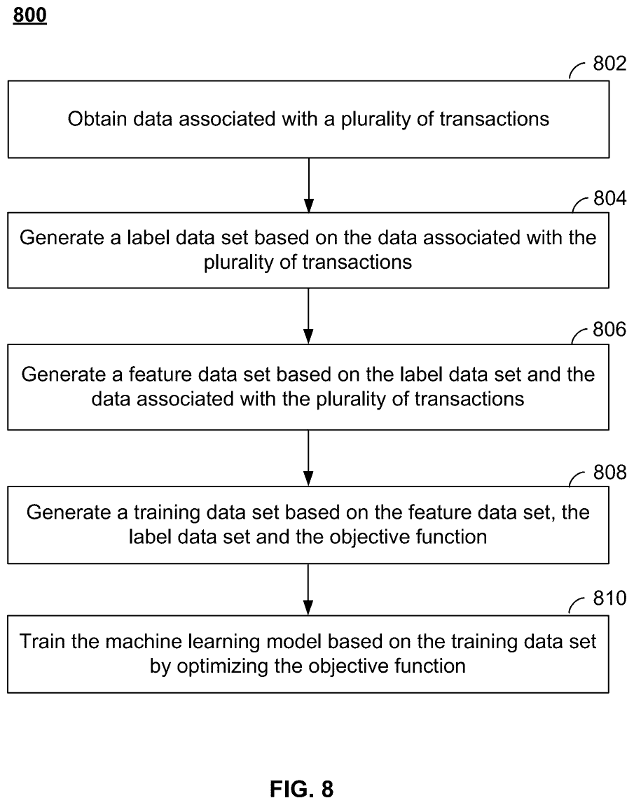

FIG. 8 shows a flowchart illustrating an example method 800 for training a machine learning model for anomaly detection, in accordance with some embodiments. In some embodiments, the method 800 can be carried out by a system including one or more computing devices, such as the anomaly detection computing device 102 and/or the cloud-based engine 121 of FIG. 1. In some embodiments, the method 800 can be performed to train the machine learning model used at the operation 706 of the example method 700 in FIG. 7. Beginning at operation 802, data associated with a plurality of transactions are obtained. At operation 804, a label data set is generated based on the data associated with the plurality of transactions. At operation 806, a feature data set is generated based on the label data set and the data associated with the plurality of transactions. At operation 808, a training data set is generated based on the feature data set, the label data set and the objective function. At operation 810, the machine learning model is trained based on the training data set by optimizing the objective function.

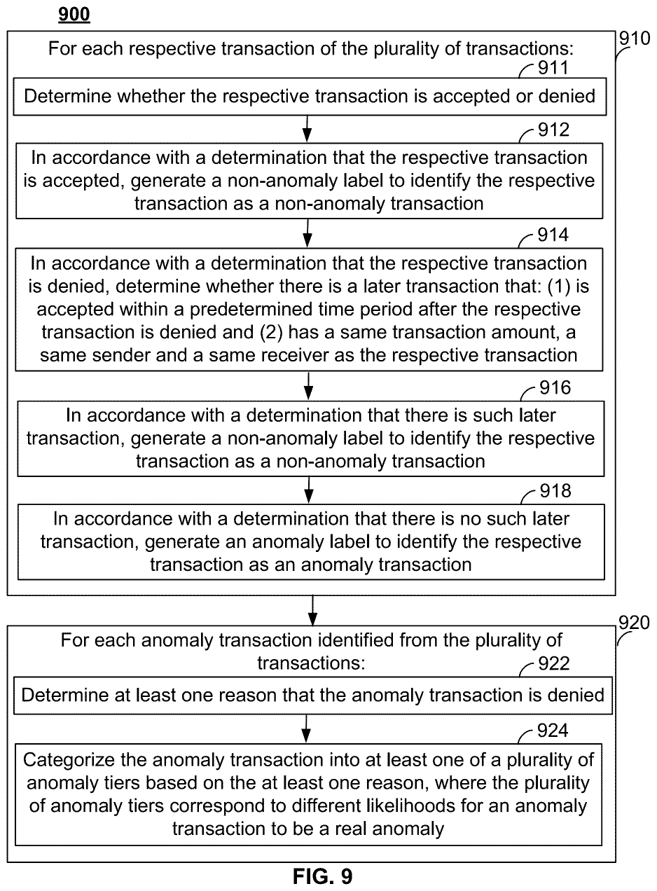

FIG. 9 shows a flowchart illustrating an example method 900 for generating a label data set, in accordance with some embodiments. In some embodiments, the method 900 can be carried out by a system including one or more computing devices, such as the anomaly detection computing device 102 and/or the cloud-based engine 121 of FIG. 1. In some embodiments, the method 900 can be performed as part of the operation 804 of the example method 800 in FIG. 8.

The operation 910 in the method 900 further includes operations 911~918 performed for each respective transaction of the plurality of transactions. At operation 911, it is determined whether the respective transaction is accepted or denied. At operation 912, in accordance with a determination that the respective transaction is accepted and not being identified as anomaly by reporting or investigating, a non-anomaly label is generated to identify the respective transaction as a non-anomaly transaction. At operation 914, in accordance with a determination that the respective transaction is denied, it is determined whether there is a later transaction that: (1) is accepted within a predetermined time period after the respective transaction is denied and (2) has a same transaction amount, a same sender and a same receiver as the respective transaction. At operation 916, in accordance with a determination that there is such later transaction, a non-anomaly label is generated to identify the respective transaction as a non-anomaly transaction. At operation 918, in accordance with a determination that there is no such later transaction, an anomaly label is generated to identify the respective transaction as an anomaly transaction.

The operation 920 in the method 900 further includes operations 922 and 924 performed for each anomaly transaction identified during the operation 910 from the plurality of transactions. At operation 922, at least one reason is determined to identify why the anomaly transaction is denied. At operation 924, the anomaly transaction is categorized into at least one of a plurality of anomaly tiers based on the at least one reason. The plurality of anomaly tiers may correspond to different likelihoods for an anomaly transaction to be a real anomaly.

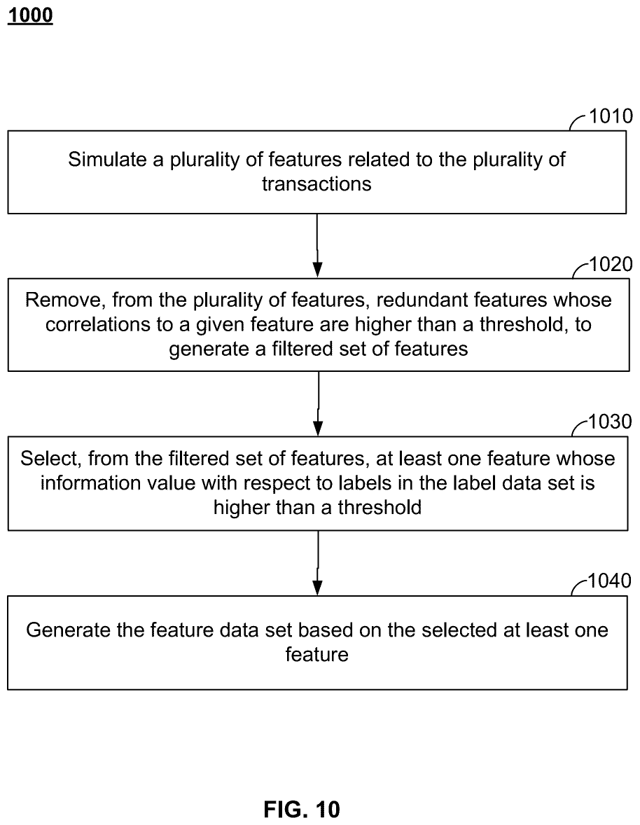

FIG. 10 shows a flowchart illustrating an example method 1000 for generating a feature data set, in accordance with some embodiments. In some embodiments, the method 1000 can be carried out by a system including one or more computing devices, such as the anomaly detection computing device 102 and/or the cloud-based engine 121 of FIG. 1. In some embodiments, the method 1000 can be performed as part of the operation 806 of the example method 800 in FIG. 8. Beginning at operation 1010, a plurality of features related to the plurality of transactions are simulated. At operation 1020, redundant features, whose correlations to a given feature are higher than a threshold, are removed from the plurality of features to generate a filtered set of features. At operation 1030, at least one feature, whose information value with respect to labels in the label data set is higher than a threshold, is selected from the filtered set of features. At operation 1040, the feature data set is generated based on the selected at least one feature.

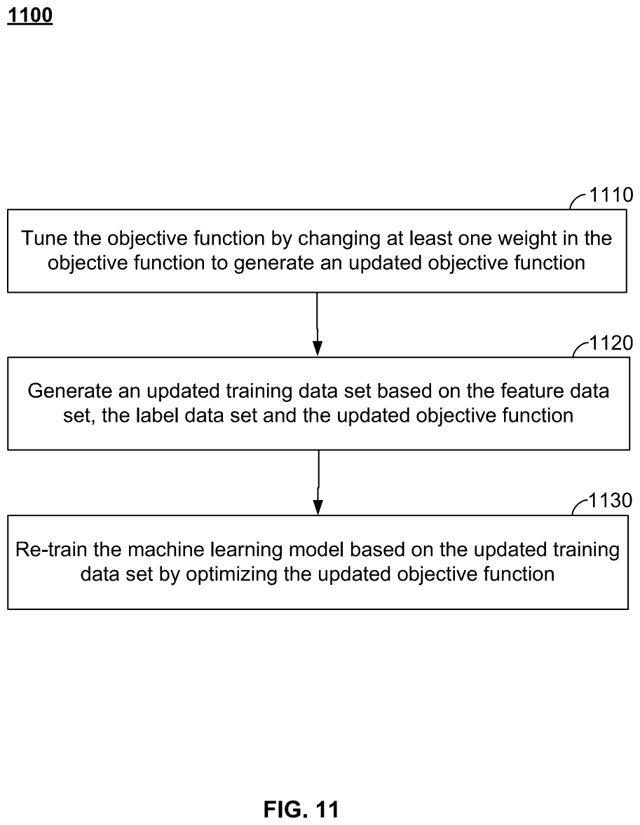

FIG. 11 shows a flowchart illustrating an example method 1100 for re-training a machine learning model for anomaly detection, in accordance with some embodiments. In some embodiments, the method 1100 can be carried out by a system including one or more computing devices, such as the anomaly detection computing device 102 and/or the cloud-based engine 121 of FIG. 1. In some embodiments, the method 1100 can be performed as part of the operation 810 of the example method 800 in FIG. 8. Beginning at operation 1110, the objective function is tuned by changing at least one weight in the objective function to generate an updated objective function. At operation 1120, an updated training data set is generated based on the feature data set, the label data set and the updated objective function. At operation 1130, the machine learning model is re-trained based on the updated training data set by optimizing the updated objective function.

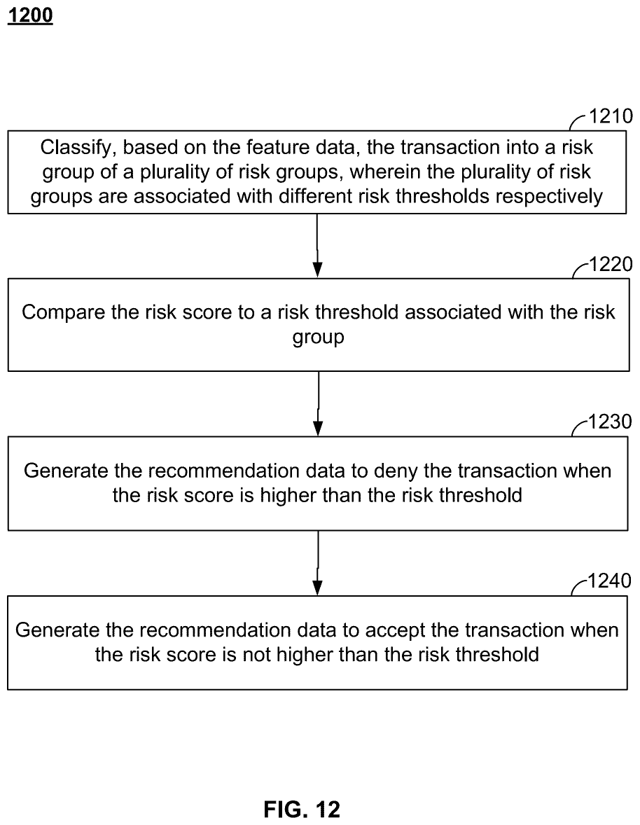

FIG. 12 shows a flowchart illustrating an example method 1200 for generating recommendation data to accept or deny a transaction, in accordance with some embodiments. In some embodiments, the method 1200 can be carried out by a system including one or more computing devices, such as the anomaly detection computing device 102 and/or the cloud-based engine 121 of FIG. 1. In some embodiments, the method 1200 can be performed as part of the operation 708 of the example method 700 in FIG. 7. Beginning at operation 1210, based on feature data of a transaction, the transaction is classified into a risk group of a plurality of risk groups. The plurality of risk groups are associated with different risk thresholds respectively. At operation 1220, the risk score is compared to a risk threshold associated with the risk group. At operation 1230, the recommendation data is generated to deny the transaction when the risk score is higher than the risk threshold. At operation 1240, the recommendation data is generated to accept the transaction when the risk score is not higher than the risk threshold.

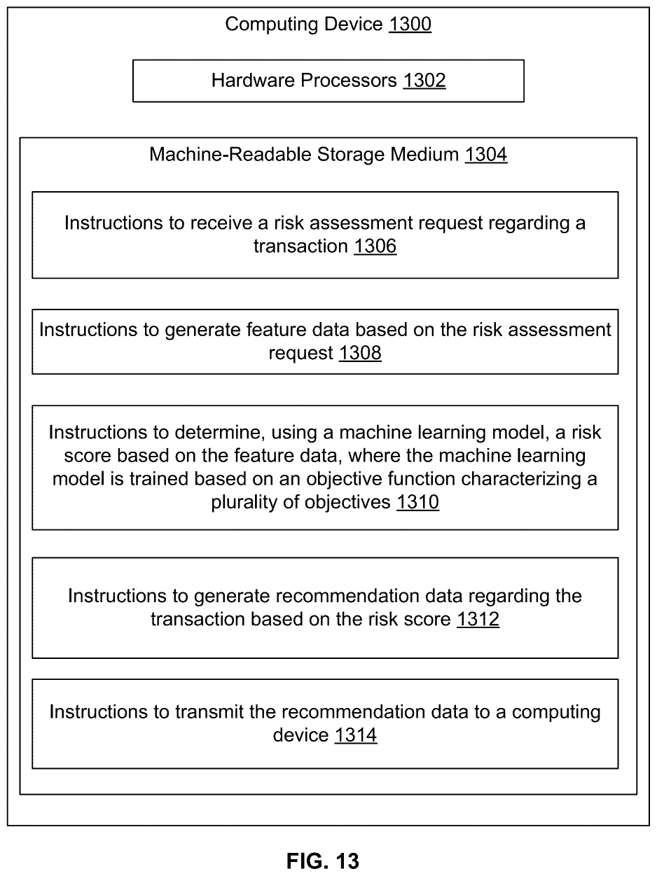

FIG. 13 depicts an example system 1300 (e.g. a computing device) for anomaly detection using machine learning, including a machine-readable medium 1304 encoded with example instructions executable by processing resource 1302, e.g. hardware processors, in accordance with some embodiments. In some implementations, the system 1300 may be useful for implementing aspects of the system 500 of FIG. 5. In some implementations, functionality described with respect to FIG. 5 may be included in the instructions encoded on machine-readable medium 1304.

The processing resource 1302 may include a microcontroller, a microprocessor, central processing unit core(s), an ASIC, an FPGA, and/or other hardware device suitable for retrieval and/or execution of instructions from the machine-readable medium 1304 to perform functions related to various examples. Additionally or alternatively, the processing resource 1302 may include or be coupled to electronic circuitry or dedicated logic for performing some or all of the functionality of the instructions described herein.

The machine-readable medium 1304 may be any medium suitable for storing executable instructions, such as RAM, ROM, EEPROM, flash memory, a hard disk drive, an optical disc, or the like. In some example implementations, the machine-readable medium 1304 may be a tangible, non-transitory medium. The machine-readable medium 1304 may be disposed within the system 1300 in which case the executable instructions may be deemed installed or embedded on the system. Alternatively, the machine-readable medium 1304 may be a portable (e.g., external) storage medium, and may be part of an installation package.

As described further herein below, the machine-readable medium 1304 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 13.

The machine-readable medium 1304 includes instructions 1306-1314. Instructions 1306, when executed, cause the processing resource 1302 to receive a risk assessment request regarding a transaction. The instructions 1308, when executed, cause the processing resource 1302 to generate feature data based on the risk assessment request.

Instructions 1310, when executed, cause the processing resource 1302 to determine, using a machine learning model, a risk score based on the feature data. The machine learning model may be trained based on an objective function characterizing a plurality of objectives. The instructions 1312, when executed, cause the processing resource 1302 to generate recommendation data regarding the transaction based on the risk score. The instructions 1314, when executed, cause the processing resource 1302 to transmit the recommendation data to a computing device.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
receive a risk assessment request regarding a transaction,
generate feature data based on the risk assessment request,
determine, using a machine learning model, a risk score based on the feature data, wherein the machine learning model is trained based on an objective function characterizing a plurality of objectives,
generate recommendation data regarding the transaction based on the risk score, and
transmit the recommendation data to a computing device.

2. The system of claim 1, wherein the feature data comprises at least one of:
a feature associated with a sender of the transaction;
a feature associated with a receiver of the transaction;
a distance between the sender and receiver; or
a frequency of transactions from the sender in a past time period.

3. The system of claim 1, wherein the machine learning model is trained based on:
obtaining data associated with a plurality of transactions;
generating a label data set based on the data associated with the plurality of transactions;
generating a feature data set based on the label data set and the data associated with the plurality of transactions;
generating a training data set based on the feature data set, the label data set and the objective function; and
training the machine learning model based on the training data set by optimizing the objective function.

4. The system of claim 3, wherein generating the label data set comprises:
for each respective transaction of the plurality of transactions:
determining whether the respective transaction is accepted or denied,
in accordance with a determination that the respective transaction is accepted and not being reported or investigated, generating a non-anomaly label to identify the respective transaction as a non-anomaly transaction,
in accordance with a determination that the respective transaction is denied, determining whether there is a later transaction that: (1) is accepted within a predetermined time period after the respective transaction is denied and (2) has a same transaction amount, a same sender and a same receiver as the respective transaction,
in accordance with a determination that there is such later transaction, generating a non-anomaly label to identify the respective transaction as a non-anomaly transaction,
in accordance with a determination that there is no such later transaction, generating an anomaly label to identify the respective transaction as an anomaly transaction; and
for each anomaly transaction identified from the plurality of transactions:
determining at least one reason that the anomaly transaction is denied,
categorizing the anomaly transaction into at least one of a plurality of anomaly tiers based on the at least one reason, wherein the plurality of anomaly tiers correspond to different likelihoods for an anomaly transaction to be a real anomaly;
for each anomaly transaction identified from the plurality of transactions.

5. The system of claim 4, wherein generating the feature data set comprises:
simulating a plurality of features related to the plurality of transactions;
removing, from the plurality of features, redundant features whose correlations to a given feature are higher than a threshold, to generate a filtered set of features;
selecting, from the filtered set of features, at least one feature whose information value with respect to labels in the label data set is higher than a threshold; and
generating the feature data set based on the selected at least one feature.

6. The system of claim 4, wherein:
the objective function comprises a weighted combination of binary indications, each of which indicates whether a transaction is categorized into a corresponding one of the plurality of anomaly tiers;
each of the plurality of objectives corresponds to an optimization over transactions in a corresponding one of the plurality of anomaly tiers; and
the machine learning model is trained further based on:
tuning the objective function by changing at least one weight in the objective function to generate an updated objective function,
generating an updated training data set based on the feature data set, the label data set and the updated objective function, and
re-training the machine learning model based on the updated training data set by optimizing the updated objective function.

7. The system of claim 1, wherein the instructions, when executed, further cause the processor to:
classify, based on the feature data, the transaction into a risk group of a plurality of risk groups, wherein the plurality of risk groups are associated with different risk thresholds respectively;
compare the risk score to a risk threshold associated with the risk group;
generate the recommendation data to deny the transaction when the risk score is higher than the risk threshold; and
generate the recommendation data to accept the transaction when the risk score is not higher than the risk threshold.

8. The system of claim 1, wherein:
the risk score represents a degree of likelihood that the transaction is an anomaly; and
the recommendation data includes one of:
a recommendation to accept the transaction; or
a recommendation to deny the transaction with a code representing a reason for denying the transaction.

9. A computer-implemented method, comprising:
receiving a risk assessment request regarding a transaction;
generating feature data based on the risk assessment request;
determining, using a machine learning model, a risk score based on the feature data, wherein the machine learning model is trained based on an objective function characterizing a plurality of objectives;
generating recommendation data regarding the transaction based on the risk score; and
transmitting the recommendation data to a computing device.

10. The computer-implemented method of claim 9, further comprising:
obtaining data associated with a plurality of transactions;
generating a label data set based on the data associated with the plurality of transactions;
generating a feature data set based on the label data set and the data associated with the plurality of transactions;
generating a training data set based on the feature data set, the label data set and the objective function; and
training the machine learning model based on the training data set by optimizing the objective function.

11. The computer-implemented method of claim 10, wherein generating the label data set comprises:
for each respective transaction of the plurality of transactions:
determining whether the respective transaction is accepted or denied,
in accordance with a determination that the respective transaction is accepted and not being reported or investigated, generating a non-anomaly label to identify the respective transaction as a non-anomaly transaction,
in accordance with a determination that the respective transaction is denied, determining whether there is a later transaction that: (1) is accepted within a predetermined time period after the respective transaction is denied and (2) has a same transaction amount, a same sender and a same receiver as the respective transaction,
in accordance with a determination that there is such later transaction, generating a non-anomaly label to identify the respective transaction as a non-anomaly transaction,
in accordance with a determination that there is no such later transaction, generating an anomaly label to identify the respective transaction as an anomaly transaction; and
for each anomaly transaction identified from the plurality of transactions:
determining at least one reason that the anomaly transaction is denied,
categorizing the anomaly transaction into at least one of a plurality of anomaly tiers based on the at least one reason, wherein the plurality of anomaly tiers correspond to different likelihoods for an anomaly transaction to be a real anomaly;
for each anomaly transaction identified from the plurality of transactions.

12. The computer-implemented method of claim 11, wherein generating the feature data set comprises:
simulating a plurality of features related to the plurality of transactions;
removing, from the plurality of features, redundant features whose correlations to a given feature are higher than a threshold, to generate a filtered set of features;
selecting, from the filtered set of features, at least one feature whose information value with respect to labels in the label data set is higher than a threshold; and
generating the feature data set based on the selected at least one feature.

13. The computer-implemented method of claim 11, wherein:
the objective function comprises a weighted combination of binary indications, each of which indicates whether a transaction is categorized into a corresponding one of the plurality of anomaly tiers;
each of the plurality of objectives corresponds to an optimization over transactions in a corresponding one of the plurality of anomaly tiers; and
training the machine learning model further comprises:
tuning the objective function by changing at least one weight in the objective function to generate an updated objective function,
generating an updated training data set based on the feature data set, the label data set and the updated objective function, and
re-training the machine learning model based on the updated training data set by optimizing the updated objective function.

14. The computer-implemented method of claim 9, further comprising:
classifying, based on the feature data, the transaction into a risk group of a plurality of risk groups, wherein the plurality of risk groups are associated with different risk thresholds respectively;
comparing the risk score to a risk threshold associated with the risk group;
generating the recommendation data to deny the transaction when the risk score is higher than the risk threshold; and
generating the recommendation data to accept the transaction when the risk score is not higher than the risk threshold.

15. A non-transitory computer readable medium having instructions stored thereon, wherein the instructions, when executed by at least one processor, cause at least one device to perform operations comprising:
receiving a risk assessment request regarding a transaction;
generating feature data based on the risk assessment request;
determining, using a machine learning model, a risk score based on the feature data, wherein the machine learning model is trained based on an objective function characterizing a plurality of objectives;
generating recommendation data regarding the transaction based on the risk score; and
transmitting the recommendation data to a computing device.

16. The non-transitory computer readable medium of claim 15, wherein the operations further comprise:
obtaining data associated with a plurality of transactions;
generating a label data set based on the data associated with the plurality of transactions;
generating a feature data set based on the label data set and the data associated with the plurality of transactions;
generating a training data set based on the feature data set, the label data set and the objective function; and
training the machine learning model based on the training data set by optimizing the objective function.

17. The non-transitory computer readable medium of claim 16, wherein generating the label data set comprises:
for each respective transaction of the plurality of transactions:
determining whether the respective transaction is accepted or denied,
in accordance with a determination that the respective transaction is accepted and not being reported or investigated, generating a non-anomaly label to identify the respective transaction as a non-anomaly transaction,
in accordance with a determination that the respective transaction is denied, determining whether there is a later transaction that: (1) is accepted within a predetermined time period after the respective transaction is denied and (2) has a same transaction amount, a same sender and a same receiver as the respective transaction,
in accordance with a determination that there is such later transaction, generating a non-anomaly label to identify the respective transaction as a non-anomaly transaction,
in accordance with a determination that there is no such later transaction, generating an anomaly label to identify the respective transaction as an anomaly transaction; and
for each anomaly transaction identified from the plurality of transactions:
determining at least one reason that the anomaly transaction is denied,
categorizing the anomaly transaction into at least one of a plurality of anomaly tiers based on the at least one reason, wherein the plurality of anomaly tiers correspond to different likelihoods for an anomaly transaction to be a real anomaly;
for each anomaly transaction identified from the plurality of transactions.

18. The non-transitory computer readable medium of claim 17, wherein generating the feature data set comprises:
simulating a plurality of features related to the plurality of transactions;
removing, from the plurality of features, redundant features whose correlations to a given feature are higher than a threshold, to generate a filtered set of features;
selecting, from the filtered set of features, at least one feature whose information value with respect to labels in the label data set is higher than a threshold; and
generating the feature data set based on the selected at least one feature.

19. The non-transitory computer readable medium of claim 17, wherein:
the objective function comprises a weighted combination of binary indications, each of which indicates whether a transaction is categorized into a corresponding one of the plurality of anomaly tiers;
each of the plurality of objectives corresponds to an optimization over transactions in a corresponding one of the plurality of anomaly tiers; and
training the machine learning model further comprises:
tuning the objective function by changing at least one weight in the objective function to generate an updated objective function,
generating an updated training data set based on the feature data set, the label data set and the updated objective function, and
re-training the machine learning model based on the updated training data set by optimizing the updated objective function.

20. The non-transitory computer readable medium of claim 15, wherein the operations further comprise:
classifying, based on the feature data, the transaction into a risk group of a plurality of risk groups, wherein the plurality of risk groups are associated with different risk thresholds respectively;
comparing the risk score to a risk threshold associated with the risk group;
generating the recommendation data to deny the transaction when the risk score is higher than the risk threshold; and
generating the recommendation data to accept the transaction when the risk score is not higher than the risk threshold.
